(19) United States
(12) Patent Application Publication
(10) Pub. No.: US 2004/0124646 A1
(43) Pub. Date: Jul. 1, 2004

(54) Pet waste collector

(75) Inventor: Douglas Martin Peko, Lyndhurst, OH (US)

Correspondence Address: WATTS, HOFFMANN, FISHER & HEINKE CO., L.P.A., Ste. 1750, 1100 Superior Ave., Cleveland, OH, 44114, US

(73) Assignee: G & D Concepts LLC

(21) Appl. No.: 10/329,738

(22) Filed: Dec. 26, 2002

(51) Int. Cl. A01K 29/00; E01H 1/12

(52) U.S. Cl. 294/1.4

(57) ABSTRACT

A device for collecting pet waste for disposal comprises an elongated handle and a fork comprising a base extending from the handle and support arms extending transversely from the base. A disposable plastic container for receiving pet waste is releasably connected to the support arms. The container has a rigidity effective to retain a preformed shape of the container despite a pushing force of a front surface of the container against the ground. Also featured is the disposable plastic container itself comprising a body including a bottom surface, front and back surfaces extending upwardly from the bottom surface and side surfaces extending upwardly from the bottom surface between the front and back surfaces. The container includes a lip extending along sides of the container around an opening into the interior of the container and a leading edge extending at a front portion of the container between the lip at the sides of the container. A lid is adapted to close the body of the container. When in a closed position the lid overhangs the leading edge and includes a cavity that receives the leading edge.

### FIELD OF THE INVENTION

The present invention relates the field of waste disposal and, in particular, to a device for collecting pet waste for disposal.

### BACKGROUND OF THE INVENTION

Under pet waste disposal laws existing in many municipalities, owners of dogs must remove their pet's solid waste left on sidewalks or neighbor's lawns. This presents pet owners with the need for a sanitary way to collect and dispose of the waste.

Pet waste has been collected in various ways using various devices, many of which are awkward or unsanitary. One way that has been used is to shovel the waste into a bag. This presents the problem of having to clean the shovel each time after use. In addition, it is inconvenient and awkward to carry a shovel when walking the dog. Another approach has been to insert one's hand into a bag, pick up the waste and then invert the bag and close it with the waste inside. People find touching pet waste through a bag to be unpleasant. In addition, bags occasionally break or have holes in them, which can soil the user.

Devices for collecting pet waste can have moving parts and can be complex. One device uses a waste pan with a door and another is a scissor-like device having an interconnected rake and pan. Other devices include a bag attached to a frame, which use the frame or a separate shovel to force the waste into the bag. One such device is shown in U.S. Pat. No. 4,875,729 which inserts a triangular shaped frame into a disposable bag. Another device stretches a bag over a shovel-like member, as disclosed in U.S. Pat. No. 6,485,073. Such devices suffer from the inherent limitations of bags: they are prone to tear or break during use or while transporting the waste. Because removing waste from grass or sidewalk may be difficult and require scraping or shoveling, bags located over the rigid frame may tear which contaminates the device. This presents the problem of dealing with the old soiled bag and cleaning the device. In addition, bags may not adequately contain the odor of the waste. Also, the user has to handle the bag in removing it from the frame and disposing of the waste, which can result in their hands becoming soiled. Bags are also undesirable in that the user and others can see the contents of the bag, making the walk unpleasant.

The present invention has been designed to overcome these and other problems of the prior art.

### SUMMARY OF THE INVENTION

In general, the present invention features a device for collecting pet waste for disposal comprising an elongated handle and a fork comprising a base extending from the handle and support arms extending transversely from the base. The support arms may extend in generally the same direction. A disposable plastic container for receiving pet waste is releasably connected to the support arms. The container has a rigidity effective to retain a preformed shape of the container despite a pushing force of a front surface of the container against the ground.

Specific features of the inventive device will now be described. The container includes a lip extending around an opening into the interior of the container; and the support arms include channels adapted to receive the lip. The channels comprise an upper surface, a side surface and a lower surface including an upwardly angled surface or ramp. The lip extends along sides of the container around the container opening. A leading edge at a front portion of the container extends between the lip at the sides of the container. The inventive device requires no rigid material between the support arms near the leading edge. The container includes a lid for closing waste inside the body. In addition, one of the lid and body includes a rectangular projection and the other includes a surface that forms a rectangular recess which frictionally engage each other when the lid is closed. This seals the waste and its odor inside the container. The device includes protrusions extending from the support arms adapted to be inserted into corresponding openings in the container. The protrusions may include angled surfaces facilitating insertion and removal of the container, which occurs mainly in a direction in which the lip extends. The angled surfaces enable the container to move off or onto the protrusions when moved in this direction. A pin near the base fits into a corresponding opening in the lid for securing the lid in an open position. A hinge connects the lid to the body. The body may have a trough shape.

A preferred aspect of the inventive device comprises:

the elongated handle;

the fork comprising the base extending from the handle and the support arms extending transversely from the base; and

the disposable plastic container for receiving pet waste releasably connected to the support arms, the container having a rigidity effective to retain a preformed shape of the container despite the pushing force of the front surface of the container against the ground, wherein the container includes the lip extending along sides of the container around the opening into the interior of the container and the leading edge extending at the front portion of the container between the lip at the sides of the, container, and the device includes no rigid material between the support arms near the leading edge,

wherein the support arms form the channel adapted to receive the lip of the container.

In particular in this preferred aspect of the invention, the protrusions extend at ends of the support arms for fitting into corresponding openings in the container, wherein the protrusions include the angled surfaces. The front of the body comprises an upper surface and a lower surface, the upper surface extending relative to the lip at an angle ranging from about 30 to about 60 degrees.

Another aspect of the present invention is directed to the disposable plastic container itself, comprising a body including a bottom surface, front and back surfaces extending upwardly from the bottom surface and side surfaces extending upwardly from the bottom surface between the front and back surfaces. The container includes the lip extending along sides of the container around the container opening and the leading edge extending at a front portion of the container between the lip at the sides of the container. The lid is adapted to close the body of the container. When in a closed position the lid overhangs the leading edge and includes a cavity that receives the leading edge, protecting the user from being soiled by pet waste on the leading edge.

More specific aspects of the container will now be described. The body includes openings disposed in a front portion of the lip. These openings can receive the protrusions on the support arms. Corrugations are formed in the body. The front surface includes the lower front surface extending upwardly from the bottom surface and the upper front surface extending upwardly from the lower front surface. The upper front surface extends at the angle ranging from 30 to 60 degrees relative to the lip. A front of the lip includes wing portions extending transverse to the side surfaces. The lid includes an opening therein, which can receive the pin disposed near the base for keeping the lid open. One of the body and the lid includes a protrusion and the other includes a recess which receives the protrusion for releasably closing the lid on the body. In addition, one of the lid and body includes the rectangular projection and the other includes the surface that forms the rectangular recess which frictionally engage each other when the lid is closed.

The inventive device offers many advantages compared to conventional ways for collecting pet waste for disposal. Rather than using bags which can easily break or tear during use or transport of the waste, the device uses a plastic container which has a rigidity effective to retain a preformed shape of the container despite a pushing force of a front surface of the container against the ground. The inventive device does not require a rigid frame member extending at the front of the device (e.g., along the leading edge) to provide the container with rigidity, even though the leading edge is used to force the waste into the container and must withstand a significant pushing force against the ground. In contrast, bags require a rigid support frame to keep the bag open and/or to shovel the waste into the bag. This causes ripping of the bag and contamination of the frame, which do not occur in the present invention because the plastic container is resistant to ripping and deformation.

Other advantages are that the containers are easily placed on and removed from the fork. The user simply slides the lip into the channels which enables the openings in the front of the container to fit onto the protrusions. The lid is conveniently able to be opened once the container is fully inserted onto the fork. It is kept out of the way in the operative position of the device by fastening to the pin near the base. The device is easy to use as it is ergonomically designed such that when the upper front surface rides on or near the ground the handle extends at an angle which is comfortable for the user. Because the device need only employ a fairly short handle, it is easy to carry. Moving parts are avoided, which leads to a device that is less complicated than prior art devices. Also, the waste is sealed inside the container which may be opaque, thereby sealing waste and its odor inconspicuously within the container. The container may be designed so as to isolate the leading edge within the cavity of the overhanging lid, thereby protecting the user from being soiled by pet waste transferred to the leading edge when it is used to force waste into the container. The container need only be used once and is easily replaced and disposed of.

Many additional features, advantages and a fuller understanding of the invention will be had from the accompanying drawings and the following detailed description.

### BRIEF DESCRIPTION OF THE DRAWINGS

FIGS. 1 and 2 are perspective views showing a pet waste collector constructed in accordance with the present invention;

FIG. 3 is a top plan view of the inventive device without its disposable container;

FIG. 4 is a side elevational view of the inventive device showing the manner in which the disposable container is inserted;

FIG. 5 is a top plan view of the device;

FIG. 6 is a side elevational view of the inventive device showing the disposable container opened and the device in an operative condition;

FIG. 7 is a partial cross-sectional view taken along the plane defined by the corresponding lines and arrows shown in FIG. 5;

FIG. 8 is a partial cross-sectional view taken along the plane shown by the corresponding lines and arrows shown in FIG. 5; and

FIG. 9 is a partial cross-sectional, detail view taken from FIG. 6.

### DETAILED DESCRIPTION

The present invention is a device 10 for collecting pet waste 12 for disposal. The device includes an elongated handle 14 and a fork or yoke 16 extending from the handle. The fork includes a base 18 and two support arms 20 extending transversely from the base in generally the same direction. The device includes a disposable plastic container 22 for receiving pet waste, which is releasably connected to the support arms. The container includes a lid 23 for closing the waste inside. In distinction to bags, the container has a rigidity effective to retain a preformed shape of the container despite a pushing force of a front surface of the container against the ground. The support arms include features enabling releasably fastening of the disposable container to the support arms.

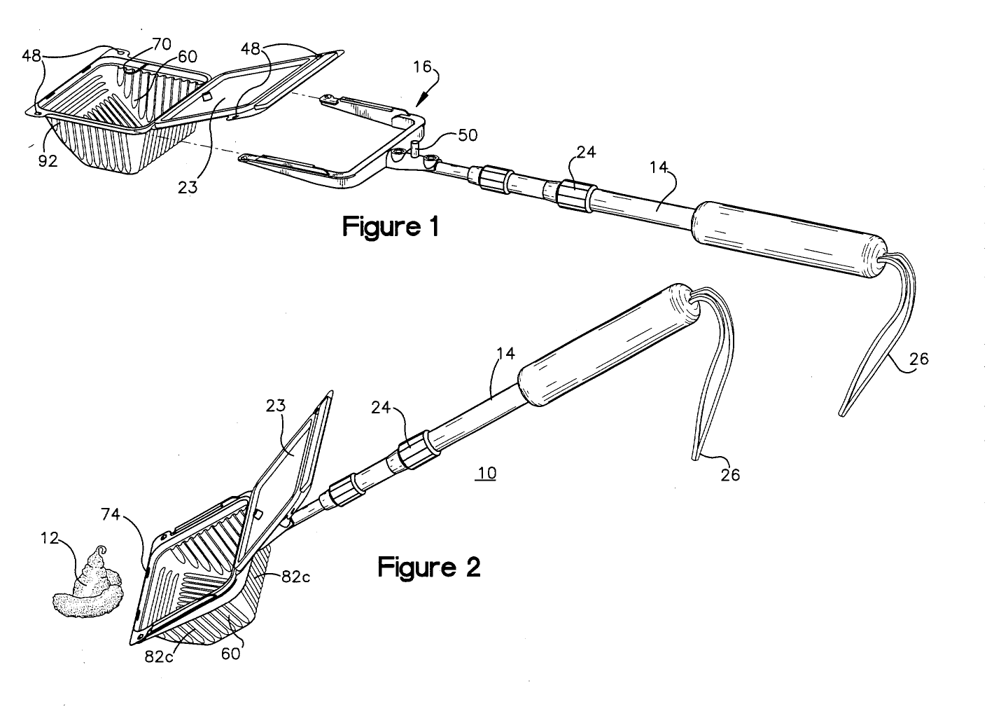

Referring now to the drawings and to FIGS. 1-4 in particular, the handle can be any length but is preferably made a short length for more convenient carrying. The handle may have a fixed length or an adjustable length as in a telescoping handle 24 known to those skilled in the art. A strap 26 may be fastened to the handle to assist in carrying the device.

The fork or yoke includes the base and opposing support arms. As seen in FIG. 4, each arm includes an upright or side surface 28, and upper surfaces 30 and lower surfaces 32, which form a channel 34 therebetween along the length of the arms for receiving the container. Referring to FIG. 4, the lower surfaces include back lower surfaces 36 and front lower surfaces 38. The back lower surfaces include upwardly extending angled surfaces or ramps 40 that facilitate proper seating of the container.

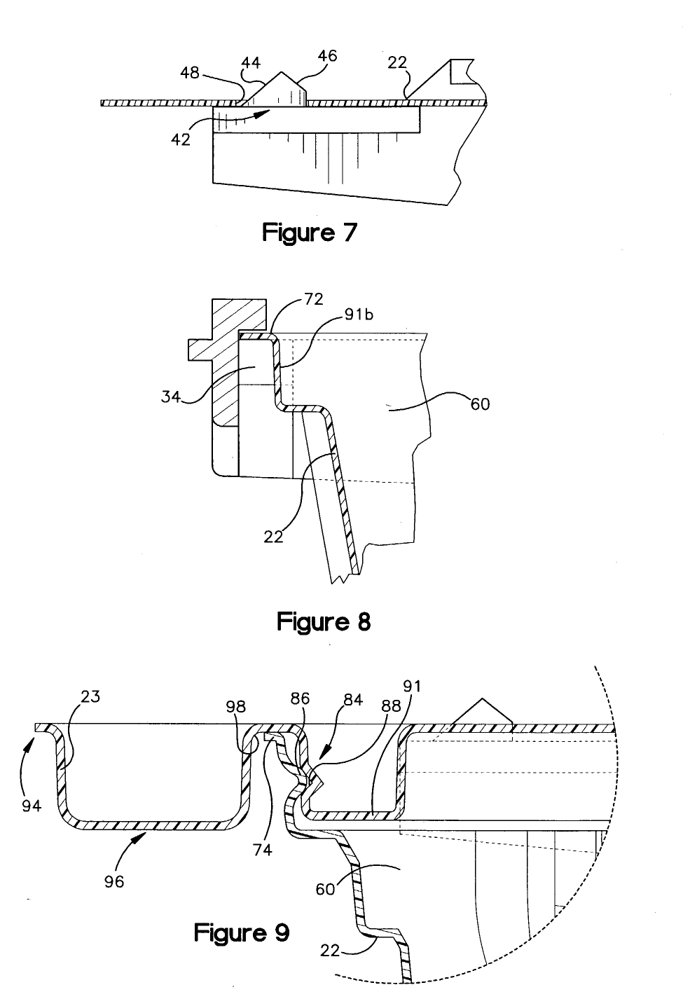

Disposed on the front lower surfaces are protrusions 42 including upper angled surfaces 44, 46 (FIG. 7), which fit into corresponding openings 48 in the container (FIGS. 1 and 7). As seen in FIG. 7, the angled surfaces 44 are leading surfaces and the angled surfaces 46 are trailing surfaces which facilitate releasably fastening the container to the support arms. Bases of the protrusions, if present, can have various shapes such as square, circular or rectangular with the angled surfaces disposed on an upper portion thereof.

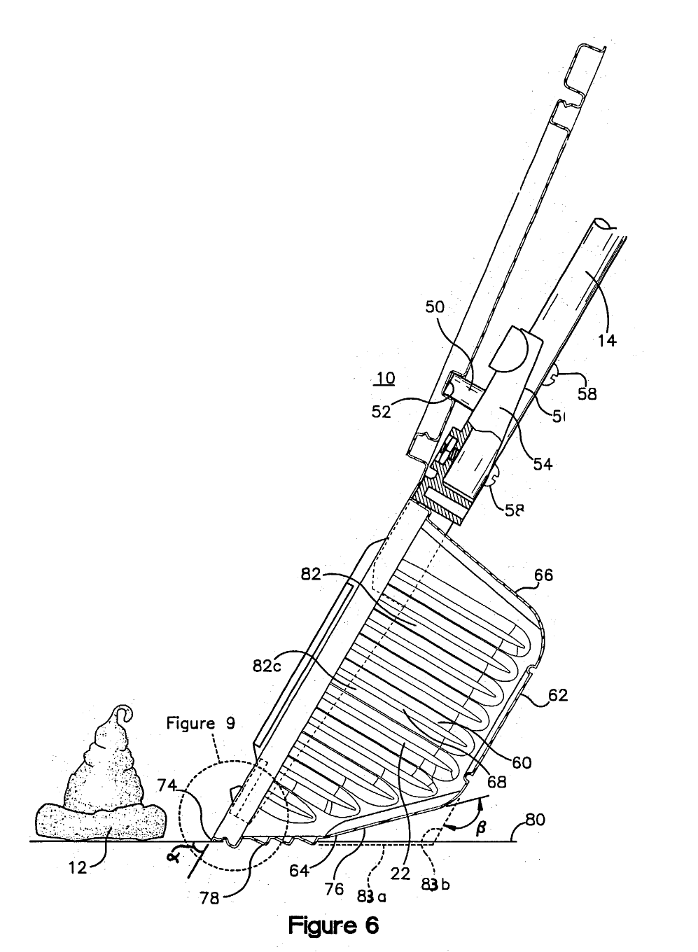

A pin 50 disposed on the yoke or handle fits into an opening 52 in the lid 23 of the container (FIG. 6) for keeping the lid open when the device is in use. In the design shown, the yoke includes a generally cylindrical, rearwardly extending section 54 which has a size sufficient to receive a generally cylindrical end 56 of the handle (FIGS. 4 and 6). The rearward section includes interiorly threaded openings for receiving fasteners 58 (such as threaded bolts and nuts) that extend through corresponding openings in the handle. The rearward section may be omitted where the device is formed of one piece.

A body 60 of the container has a trough-shape, for example. It will be understood, however, that other shapes of the container may also be suitable. The lid 23 is connected to the body for closing the container. As shown in FIG. 6, the body includes a bottom surface 62, front surface 64 and back surface 66 extending upwardly from the bottom surface and two side surfaces 68 extending upwardly from the bottom surface between the front and back surfaces. The body includes an upper opening 70 leading to its interior volume and a lip 72 extending around the upper opening. Portions of the lip which extend along the sides of the container are received in the channels of the support arms. At the front of the container is a leading edge 74 extending between the support arms.

As shown in FIG. 6, the front surface 64 of the container may include a compound angle formed by an angled lower front surface 76 extending upwardly from the bottom of the container and an angled upper front surface 78 extending upwardly from the lower front surface to the leading edge. The angle of the upper front surface may be selected to enable the device to be used in an ergonomic fashion. That is, suitable angles dictated by the way the user holds the device when pushing it along the ground, whether in a crouched position, bent-over position or standing, can be used in the inventive design, as would be apparent to those skilled in the art in view of this disclosure. The angle α, between the upper front surface 78 and the lip when it is retained in the channels of the support arms, is preferably the angle at which the device is used relative to the ground, depicted by line 80. The upper front surface will be placed on or near the ground with the handle extending at the angle α relative to the ground. As shown in FIG. 6, the angle α ranges from about 30 to about 60 degrees, and in particular, is about 45 degrees or less. The device is pushed by the user such that the leading edge forces waste into the container by a scraping action of the leading edge 74 against or near the ground (e.g., on grass, sidewalk or other hard or soft surface).

The lower front surface extends at an angle β relative to the bottom surface, that enables the interior volume of the container to be maximized, while at the same time is small enough relative to the upper front surface that the lower front surface does not bump into the ground when the device is being used. The deeper the container is, the smaller the angle β may be, as shown by comparing angle β1 of the lower front surface of the container shown in FIG. 4 with smaller angle β2 of the lower front surface of the deeper container shown by dotted lines, to allow for clearance from the ground when using the device, and vice versa for shallower containers. Alternatively, the inventive container may include only one front surface from the bottom to the leading edge rather than a compound surface, by extending upper front surface 78 with surface 83a and extending the bottom 62 with bottom surface 83b, as shown in FIG. 6.

The container has a rigidity effective to retain a preformed shape of the container despite a pushing force of the front surface of the container and/or leading edge against the ground. In contrast, bags are not rigid and cannot retain a preformed shape when a pushing force against the ground is applied to them. It is believed that the inventive design in which the lid is supported by the channels and/or protrusions, provides added rigidity or strength to the plastic container. A suitable plastic material for the yolk is known as ABS, which is a copolymer of acrylonitrile, butadiene and styrene. A suitable material for the container is high impact polystyrene colored black having a thickness ranging from about 0.015 to 0.025 inch, in particular, 0.020 inch. The container is formed in a well known manner such as by vacuum suction molding.

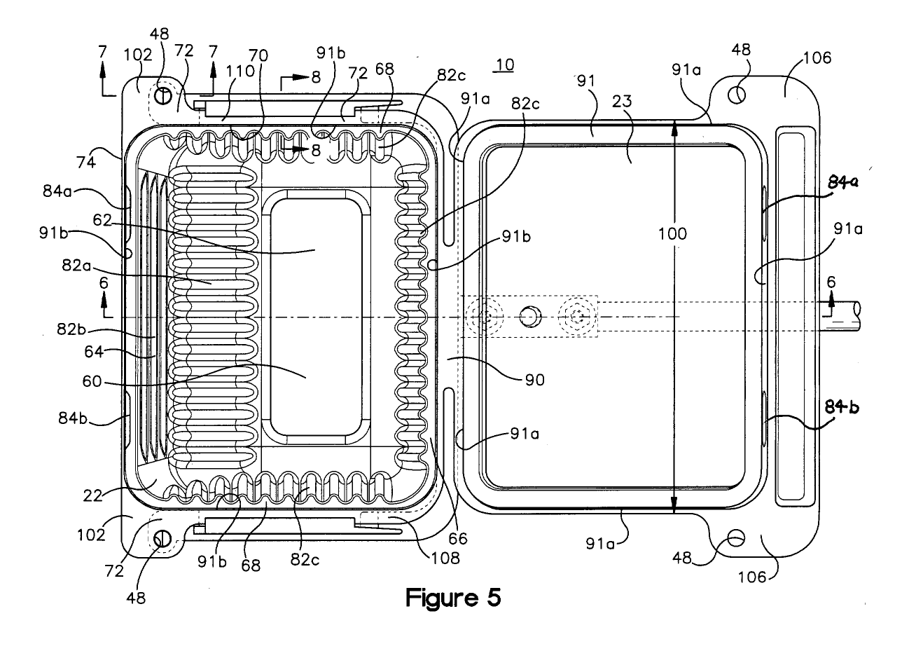

Corrugations 82 in the body strengthen it, permitting it to be formed of a thin plastic material, which is advantageous from the standpoint of ease of fabrication and low cost, and provide the container with sufficient strength to withstand the normal load imposed by pushing the device against the ground so as to force the waste into the container during ordinary operation. The pattern of corrugations shown in FIG. 5 is believed to suitably strengthen the container, and includes vertically extending corrugations 82a on the lower front surface and horizontally extending corrugations 82b on the upper front surface (FIG. 5). Vertically extending corrugations 82c are disposed on the side and back surfaces. Other suitable patterns and types of corrugations would be appreciated by those skilled in the art in view of this disclosure.

The container has a latch 84 including two latch components 84a, 84b (FIG. 5) each comprised of an inwardly extending protrusion 86 on the body that is generally v-or u-shaped in cross-section and a corresponding outwardly facing recess 88 on the lid that is generally v- or u-shaped in cross-section (FIG. 9). The inventive design contemplates making the latch such that the body includes the recess and the lid includes the protrusion. Other latches suitable for use in the present invention would be apparent to those skilled in the art in view of this disclosure. The engagement of the protrusion and recess keeps the container closed.

The lid is connected to the body with a suitable hinge 90. The exemplary hinge shown is a perforated hinge in which the lid and body are formed of one piece of plastic.

The lid also seals the body closed. An inwardly extending rectangular projection 91 (FIG. 5) has an outer surface 91a that frictionally engages a surface forming a corresponding rectangular opening 91b in the body. An interference fit between the rectangular projection surface 91a and the surface that forms the rectangular opening 91b, formed substantially completely around the lid, seals pet waste and odor inside the container.

As shown in FIGS. 1 and 2, the lip or peripheral flange extends near an upper surface 92 of the body around the opening 70. The leading edge 74 is withdrawn from the forward most end 94 of the container when it is closed, as shown in FIG. 9. That is, the front of the lid, which is kept open during use of the device, extends more forwardly than, or overhangs at 96, the leading edge 74 of the body when the container is closed. A cavity 98 formed in the lid receives the contaminated leading edge 74 when the lid is closed, which makes the device sanitary in that any waste that has been transferred to the leading edge during use of the device will be prevented from soiling the user.

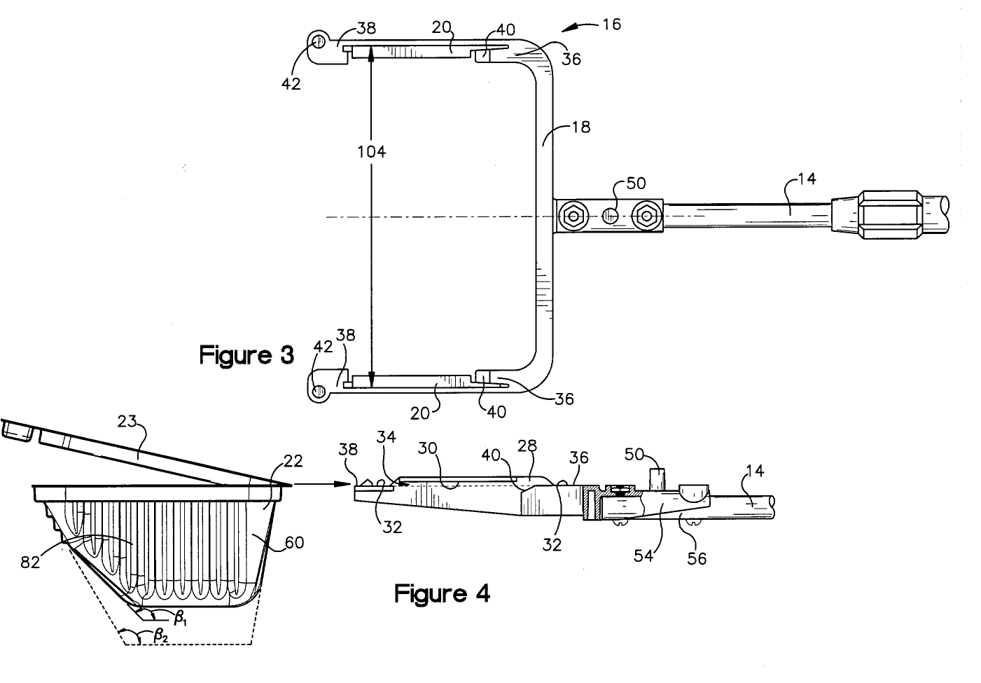

Referring to FIG. 5, the width 100 of the lid 23 is of a size (smaller than distance 104) that permits clearance from the channels when the container is connected to the yoke. This enables the container to be inserted onto the yoke while it is closed, which is easier for the user. Even when the lip 72 is received in the channels 34 and the container is fully inserted onto the yoke, the user can open the lid. The front of the lip includes wing portions 102 which extend outwardly at a width greater than distance 104 between the side surfaces of the support arms (FIG. 3). The front of the lid also includes wing portions 106 that have a size and shape corresponding to the wing portions of the body. The protrusions 42 serve to maintain the wing portions of the body in place when the device is being used and, when the lid is closed, retain the wing portions of the body and lid in contact with each other.

In operation, the user inserts a new container 22 onto the yoke by pushing the lip of the closed container into the channels in the support arms in the direction shown by the arrow in FIG. 4. During insertion, rearward portions 108 of the lip (FIG. 5) will first be disposed between the front lower surfaces and upper surfaces of the support arms and then, as the container continues to be moved toward the base, the rearward portions 108 of the lip will clear the front lower surfaces and contact the ramps 40 which move it onto the rear lower surfaces. Because a more forward portion 110 of the lip will be disposed between the lower front surfaces and upper surfaces when the rearward portion of the lip engages the ramp, the lip is maintained generally parallel to the upper surfaces so as to prevent the rearward portion of the lip from traveling below the ramp during insertion of the container. As seen from the top view of FIGS. 3 and 5, the lip is supported in the channels 34, substantially continuously from the front to back of the yoke, by the lower front surfaces 38, by the upper surfaces 30 and by the lower rear surfaces 36. The exemplary design enables the use of less material compared to upper and lower surfaces that extend all the way from the front of the support arms to the rear of the support arms. However, it should be apparent that the present invention also covers the use of channels which are formed by upper and/or lower surfaces which extend along a greater extent (as shown by the longer lower surface represented by the dotted lines in FIG. 4), or the entire length of the support arms, in which cases the ramps may be omitted.

Once the container has been nearly completely inserted onto the yoke, the wing portions 102 of the lip will contact the leading angled surfaces 44 of the protrusions (FIG. 7), which facilitates seating the protrusions into the openings. The container is now retained onto the support arms by the channels and the protrusions (see FIGS. 7 and 8).

When the user would like to clean up pet waste such as from a dog, for example, the container is opened by lifting the lid 23 and disengaging the latch, i.e., by disengaging the recesses 88 on the lid from the protrusions 86 on the body. The outer surface 91a of the rectangular projection 91 is disengaged from the surface that forms the rectangular opening 91b. The lid is also disengaged from the protrusions 42 and, when fully open, the opening 52 of the lid receives the pin 50 to keep the lid open, which further anchors the container to the yoke.

If an adjustable length handle is used in the design, the user may extend the handle to a desirable length. As shown in FIG. 6, the user then cleans the solid waste from an area (e.g., the grass or sidewalk) by pushing the device so that the upper front surface 78 rides on or near the ground and the leading edge 74 gives a shoveling effect which causes the waste to enter the interior of the body of the container. The container withstands the pushing force upon the leading edge even without a strengthening member extending between the front portions of the arms. The container is then closed by disengaging the opening 52 in the lid from the pin 50, placing the lid once again over the protrusions 42, and reengaging the latch 84 as well as the rectangular projection surface 91a with the surface that forms the rectangular opening 91b to close the container securely and seal the waste inside. As shown in FIG. 9, when the container is completely closed, the leading edge 74 is isolated within the cavity 98, which prevents the user from being soiled by waste transferred to the leading edge. The inventive device is designed so that the container need only be used once. Once pet waste has been deposited in the container, the container is removed from the yoke while closed, by lifting it upward or simply twisting it slightly to disengage the protrusions 42 from the openings 48. The angled trailing edges 46 may facilitate removal from the protrusions 42. The container is then slid off the yoke and disposed of. A new container is then inserted onto the yoke in the manner described. The containers may be stored in a nested condition as a result of their trough shape.

Many modifications and variations of the invention will be apparent to those skilled in the art in light of the foregoing disclosure. Therefore, it should be understood that, within the scope of the following claims, the invention can be practiced otherwise than has been specifically shown and described.

What is claimed is:

1. Device for collecting pet waste for disposal comprising:
an elongated handle;
a fork comprising a base extending from said handle and support arms extending transversely from said base; and
a disposable plastic container for receiving pet waste releasably connected to said support arms, the container having a rigidity effective to retain a preformed shape of the container despite a pushing force of a front surface of the container against the ground.

2. The device of claim 1 comprising protrusions extending from said support arms adapted to be inserted into corresponding openings in the container.

3. The device of claim 1 comprising protrusions extending from said support arms adapted to be inserted into corresponding openings in the container, wherein said protrusions include angled surfaces.

4. The device of claim 1 wherein said container includes a lip extending around an opening into the interior of the container and said support arms include channels adapted to receive said lip.

5. The device of claim 1 wherein said container includes a lip extending around an opening into the interior of the container and said support arms include channels adapted to receive said lip, said channels comprising an upper surface, a side surface and a lower surface including an upwardly angled surface.

6. The device of claim 1 wherein said container includes a lip extending along sides of the container around an opening into the interior of the container and a leading edge extending at a front portion of the container between the lip at the sides of the container, and wherein said device includes no rigid material between the support arms near said leading edge.

7. The device of claim 1 wherein the container includes a lid for closing the container.

8. The device of claim 1 wherein the container includes a lid for closing the container and further comprises a pin near said base fitting into a corresponding opening in said lid for securing said lid in an open position.

9. The device of claim 1 wherein the container includes a lid for closing the container and a hinge connecting said lid to said body.

10. The device of claim 1 wherein the container includes a lid for closing the container and one of the lid and the body includes a rectangular projection and the other includes a surface that forms a rectangular recess which frictionally engage each other when the lid is closed.

11. The device of claim 1 wherein the body has a trough shape.

12. Device for collecting pet waste for disposal comprising:
an elongated handle;
a fork comprising a base extending from said handle and support arms extending transversely from said base; and
a disposable plastic container for receiving pet waste releasably connected to said support arms, the container having a rigidity effective to retain a preformed shape of the container despite a pushing force of a front surface of the container against the ground,
wherein said support arms include means for releasably fastening said container to said support arms.

13. Device for collecting pet waste for disposal comprising:
an elongated handle;
a fork comprising a base extending from said handle and support arms extending transversely from said base; and
a disposable plastic container for receiving pet waste releasably connected to said support arms, the container having a rigidity effective to retain a preformed shape of the container despite a pushing force of a front surface of the container against the ground, wherein said container includes a lip extending along sides of the container around an opening into the interior of the container and a leading edge extending at a front portion of the container between the lip at the sides of the container, and said device includes no rigid material between the support arms near said leading edge,
wherein said support arms form a channel adapted to receive the lip of the container.

14. The device of claim 13 comprising protrusions extending at ends of said support arms for fitting into corresponding openings in the container, wherein said protrusions include angled surfaces.

15. The device of claim 13 wherein a front of said body comprises an upper surface and a lower surface, said upper surface extending relative to said lip at an angle ranging from 30 to 60 degrees.

16. A disposable plastic container for collecting pet waste comprising
a body including a bottom surface, front and back surfaces extending upwardly from the bottom surface and side surfaces extending upwardly from the bottom surface between the front and back surfaces, wherein said container includes a lip extending along sides of the container around an opening into the interior of the container and a leading edge extending at a front portion of the container between the lip at the sides of the container; and
a lid adapted to close the body of the container, wherein when in a closed position said lid overhangs said leading edge and includes a cavity that receives said leading edge.

17. The container of claim 16 wherein said body includes openings disposed in a front portion of the lip.

18. The container of claim 16 comprising corrugations formed in the body.

19. The container of claim 16 wherein said front surface includes a lower front surface extending upwardly from the bottom surface and an upper front surface extending upwardly from the lower front surface, said upper front surface extending at an angle ranging from 30 to 60 degrees relative to said lip.

20. The container of claim 16 wherein a front of said lip includes wing portions extending transverse to the side surfaces.

21. The container of claim 16 wherein said lid includes an opening therein.

22. The container of claim 16 wherein one of said body and said lid includes a protrusion and the other includes a recess which receives said protrusion for releasably closing said lid on said body.

23. The container of claim 16 wherein the container includes a lid for closing the container and one of the lid and the body includes a rectangular projection and the other includes a surface that forms a rectangular recess which frictionally engage each other when the lid is closed.
